(19) United States
(12) Patent Application Publication
(10) Pub. No.: US 2026/0217007 A1
(43) Pub. Date: Jul. 30, 2026

(54) Multilayer plate or panel

(71) Applicant: Renolit GOR S.p.A., Buriasco (TO) (IT)

(72) Inventors: Andrea Strignano, Torino (IT); Simone Collino, San Secondo di Pinerolo (TO) (IT)

(21) Appl. No.: 19/145,269

(22) PCT Filed: Jan. 11, 2024
(86) PCT No.: PCT/IB2024/050287

§ 371 Date: Jul. 2, 2025

(30) Foreign Application Priority Data
Jan. 11, 2023 (IT) 102023000000219

(51) Int. Cl. B32B 27/12; B32B 5/02; B32B 5/18; B32B 5/24; B32B 27/06; B32B 27/32

(52) U.S. Cl. CPC B32B 27/12; B32B 5/022; B32B 5/18; B32B 5/245; B32B 27/065; B32B 27/32; B32B 2250/04; B32B 2250/05; B32B 2250/24; B32B 2260/021; B32B 2262/0253; B32B 2262/0284; B32B 2307/546; B32B 2307/558; B32B 2307/718; B32B 2307/72; B32B 2307/7376; B32B 2607/00

(57) ABSTRACT

A multilayer plate or panel has at least three layers superimposed and coupled to each other, which include an intermediate core layer and two covering layers, or skin layers, coupled to its opposite faces and made from a thermoplastic material. The two covering layers include an extruded film of plastic material or thermoplastic fibers mixed or intertwined with other fibers, synthetic or natural, which are bonded and/or fixed only thermally and/or by simultaneous compression to a respective face of the intermediate layer, which also contains a thermoplastic material in the form of an agglomerate or of a set of thermoplastic fibers, which may be mixed with other fibers, synthetic or natural.

The object of the invention is a multilayer plate, comprising at least three layers superimposed and coupled to each other and which layers comprise at least one intermediate core layer to each of whose opposite faces at least one covering layer is coupled, also referred to as a skin layer.

This type of plates are known to the state of the art and said at least three layers are made with different types of materials or mixtures of materials and with different types of material structures, as well as with different thicknesses. Further known variations also relate to the methods of coupling the layers together and/or to the manufacturing processes of said layers.

In the field of plates of the aforementioned type, the different combinations indicated above are chosen on basis the of the optimization of contrasting characteristics such as for example the mechanical resistance, the weight and/or thickness of the layers and therefore of the plate, the three-dimensional formability of the plate or the possibility of imprinting three-dimensional patterns on the faces of the plate, resistance to extreme temperatures, the presence of fireproof or flame resistance characteristics, the resistance of materials and couplings to humidity and other characteristics.

In particular, in several fields of application, including, for example, but not limited to the automotive field, it is generally necessary to settle for a compromise between one or more of the characteristics relating to the weight of the plates, the thickness of the plates, the aesthetic characteristics of the plates and their formability as opposed to one or more mechanical characteristics, such as the of rigidity the plates at room temperature and impact resistance.

A further limitation to consider when it is necessary to optimize the aforementioned one or more contrasting characteristics is also related to the type of materials which according to current standards must be at least recyclable if not also corresponding to low CO2 production parameters.

In particular, in the automotive sector the current and best compromises between the parameters of aesthetic characteristics, mechanical characteristics and thickness and weight, especially for internal lining panels of bodies or cells for housing loads of vehicles with a substantially two-dimensional shape (2-D), are obtained thanks to plates or panels of plastic or composite materials or wood, which have a weight per unit area of approximately 1300 to approximately 5000 g/m2 when the said plates or the panels are made of plastic material and whose weight increases considerably until reaching a weight per unit of surface of about 5000 to about 8000 g/m2 when the plate or panel material includes at least one wooden component or one or more metallic finishing layers, such as aluminium or the plate is made entirely of wood. As regards the thicknesses of state-of-the-art plate or panels with the aforementioned characteristics, these are currently between approximately 2 and 5 mm.

Document WO2018169851A1 describes a multilayer plate comprising at least four layers of which an expanded core layer of the closed cell type.

The overall thickness of the plate is greater than 6 mm since this thickness is indicated as the minimum thickness after a lofting process of the material which forms at least one covering layer. Furthermore, at least one of the covering layers is also made up of an expanded layer. An application of the said plate for the construction of floors which has a resistance to load bending is described. Furthermore, the layers are coupled together using adhesives to avoid delamination.

US2006289231 describes a plate for the creation of sound-absorbing panels which are intended to be placed against metal separation walls, for example towards an engine compartment. The plates comprise no fewer than four layers. A core layer is provided which constitutes a sound-absorbing layer and which is coupled directly or with the interposition of a further waterproofing layer to a barrier layer. A further layer coupled to the core layer consists of a layer to increase acoustic performances. For the core layer, thicknesses ranging from 15 to 40 mm and weights ranging from 290 to 1100 g/m² are foreseen. The overall thickness is therefore decidedly high and considering the presence of the other layers, it exceeds 15 mm.

The aim of the present invention is to create a plate or panel of the aforementioned type which, thanks to relatively simple and inexpensive measures, allows the mechanical characteristics to be kept as close as possible to those of known plates, further the limiting the weight and/or even possibly thickness.

According to a first embodiment of the present invention, the aforementioned purposes are achieved with a multilayer plate or panel, comprising at least three layers superimposed on each other and coupled to each other and which layers comprise at least one intermediate layer of core to each of whose opposite faces there is coupled at least one covering layer, also known as a skin layer, and in which the said layers are made up of thermoplastic materials, the said two covering layers being constituted by a continuous extruded film of plastic material, the in which at least two coating layers are bonded and/or thermally fixed to a respective face of said intermediate layer, also made of thermoplastic material and in the form of an agglomerate or set of thermoplastic fibres, and in which said agglomerate of fibers is obtained by compression one and simultaneous heating from a pre-established initial thickness to a final thickness of approximately 1 mm to approximately 3.8 mm having an average density of 50 to 300 Kg/m³ and a weight per surface unit of 250 to 500 g/m2.

According to one embodiment, said agglomerate of thermoplastic fibers is made up of one or optionally more layers of non-woven fabric of thermoplastic fibres.

In an embodiment, in particular the one in which the core layer comprises an agglomerate of thermoplastic fibres, for example, in the form of non-woven fabric, the said core layer has so-called open cells.

According to a further characteristic which is provided in combination with one or more of the previous characteristics, the at least two coating layers coupled respectively to one of the two opposite faces of the intermediate core layer each have a thickness of the order of magnitude between 200 and 400 microns.

In an executive variant the intermediate core layer is made up of one or more layers of an expanded thermoplastic material, in particular with closed cells, and also in this variant, the said core layer has a density of from 50 to 300 Kg/m3.

According to a further characteristic, the expanded thermoplastic material can be made up of EPP expanded polypropylene or cross-linked expanded polyethylene or EPE expanded polyethylene.

In an embodiment in which the core layer is made of foamed material as indicated above, said core layer is of the closed cell type.

The overall thickness of the plate or panel including the said at least one core layer and the at least two cladding layers has an overall thickness of 2 to 4 mm and an overall weight of 800 to 1000 g/m2. as regards the choice of thermoplastic materials of which the said at least three layers are made, it is advantageous to select the said materials so as to obtain maximum of the chemical compatibility thermoplastic materials of which the said at least three layers are made.

An executive variant can provide that at least one of the said two covering layers are different from each other in relation to one or more of the characteristics relating to the type of thermoplastic material of which they are composed, the thickness and optionally also in relation to the nature of the coupling process.

A further characteristic provides for compatibility between the materials that make up the said at least three layers and when possible further additional layers, which compatibility relates to the possibility of recycling the entire plate or the entire panel without having to separate the layers from each other.

A feature that contributes to making the plate according to the present invention more suitable for recycling and which at the same time reduces the weight of said plate, helping to keep it within the range of the measurements indicated above, provides that the layers that form said plate are coupled together by means of a coupling process which does not include an adhesive between said layers, but said layers are coupled by thermobonding, i.e. heating and compressing said layers against each other.

According to yet another characteristic, the non-woven fabric of thermoplastic fibers has thermoplastic fibers that adhere to each other through chemical-physical coupling at points of contact of the said fibers with each other, forming a network of fibers connected to each other which delimit hollow areas between them.

This effect of adhesion of the non-woven fabric fibers to each other can be obtained prior to the coupling of said layer of non-woven fabric with the at least two covering layers, for example during the hot compaction phase from the first initial thickness to the final thickness of the said agglomerate of fibers that forms the core layer, or upon coupling with the said at least two covering layers by thermobonding. In these processes, the fibers of the said non-woven fabric are subjected to a transient heating which determines a transient softening of the fibers and mutual adhesion of the same at the points of contact of the fibers with each other.

At the end of this transient heating, the fibers remain joined together at the contact points, while they again take on at least in part the mechanical characteristics they had before said transient heating, thus generating network of fibres, in particular cells open.

According to an executive variant, at least one of the said two covering layers can present a multilayer structure being made up of at least two layers coupled together.

In an embodiment one of said at least two layers comprises a thermoplastic film on which at least one further layer is superimposed and coupled on the face of said film which is opposite to the intermediate core layer and/or on the face of said film facing towards the called the intermediate layer of the nucleus.

In one embodiment, said further layer coupled to the thermoplastic film can be constituted by a layer of thermoplastic fibers possibly mixed or intertwined with synthetic and/or natural fibres, also with a thickness of the order of magnitude from 200 to 400 microns and which is also coupled by thermobonding or which is incorporated and/or mutually permeated with the covering layer.

Yet another possible variant provides that the intermediate core layer is made up of two or a plurality of fiber layers, at least one of which is in the form of a non-woven fabric of thermoplastic fibers and the further layer(s) of fibers also in the form of fabric non-woven or of fibers intertwined with each other, the prevailing orientation of the fibers of each of the said layers of fibers being identical or different from layer to layer.

In this case the overall thickness of the said two or more layers of fibers that constitute the intermediate core layer is substantially identical to that of an intermediate layer of single-layer core, and/or the weight per unit of surface is also included from approximately 250 to approximately 500 g/m2.

An executive variant provides for the thermoplastic material of the said at least two cladding layers and for the fibers of the said intermediate core layer and/or for any possible one or more further layers coupled to the cladding layers the same thermoplastic material such as in particular a polyolefin resin or a blend of polyolefin polymers and/or copolymers such as polypropylene.

Still according to an executive variant, the said at least two coating layers and/or optionally the said one or more additional layers coupled to at least one of the coating layers can have thicknesses different from each other such that the overall thickness of the layer covering the intermediate layer of core is different from face to face of the plate or panel.

Depending on whether, in the particular type of use of the plate and/or the constructive or structural part manufactured from said plate, requirements for mechanical resistance and/or thermoformability and/or reduced weight and/or recyclability and/or fire resistance prevail, it is possible to vary the number and type of polymeric coating layers and/or fire barrier layers coupled to one or both faces of the first layer.

The aforementioned variants and embodiments, when compatible, can be provided in any combination or sub-combination with each other.

The plate according to the present invention has mechanical characteristics, such as flexibility, weight, impact resistance and thermoformability in combination with a relatively thin thickness and with a weight limited to a maximum of 1000 g/m2, thus constituting an excellent compromise solution compared to currently possible solutions.

In particular, the aforementioned plates according to the present invention are at the same time thermoformable, i.e. they have the possibility of being three-dimensionally shaped using traditional molding processes or they can be subjected to processes of impression of three-dimensional surface patterns.

They allow you to achieve impact resistance values significantly higher than those of state-of-the-art plates.

The term good thermoformability refers to the fact that they through hot molding processes at least according to current forming technologies, without these three-dimensional deformations generating stretching phenomena and therefore excessive reduction in thickness and therefore local weakening in the thermoformed products. Ulteriori caratteristiche sono oggetto delle rivendicazioni indipendenti.

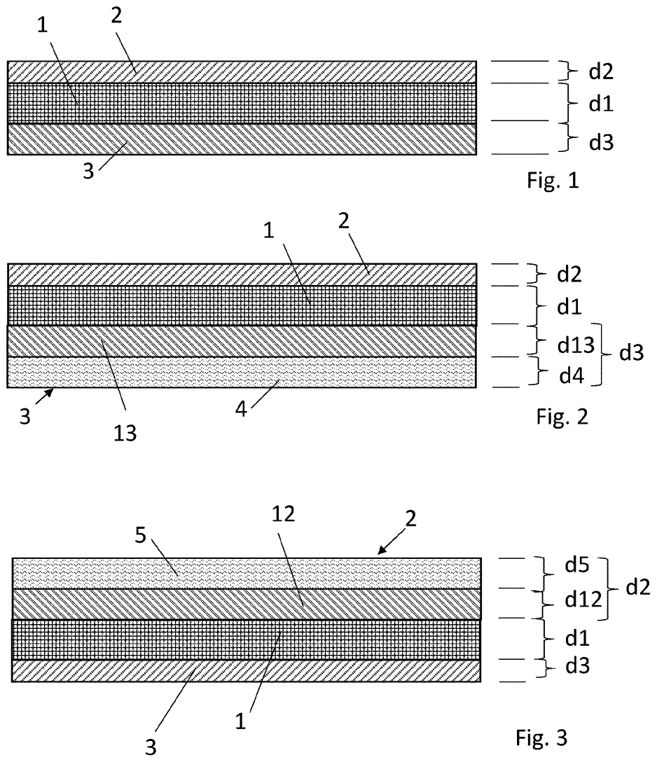

FIGS. 1 to 4 schematically show a cross section of several alternative exemplary embodiments of a plate according to the present invention.

FIG. 1 shows a plate made up of an intermediate core layer 1, to which a covering layer 2, 3 is coupled on each face. The core layer 1 has a thickness d1, while the cladding layer 2 has a pre-established thickness d2 and the cladding layer 3 on the opposite face of the intermediate core layer 1 has a pre-established thickness d3.

The thicknesses of the coating layers d2 and d3 preferably vary from about 200 to about 400 microns and can be the same as each other or even different as illustrated by way of example only in FIG. 1.

The thickness d1 of the intermediate layer of core 1 is set to a value such that the overall thickness of the said three layers, i.e. the sum of the respective thicknesses d1, d2 and d3 has a value from about 2 to about 4 mm and according to a shape executive can be between 1 and 3.8 mm.

According to an embodiment of the present invention, the intermediate core layer 1 can be constituted at least by an agglomerate and/or a set of fibers such as, for example, a non-woven fabric. In particular, the fibers are made of thermoplastic material, which can also be a mixture of different thermoplastic polymers.

An executive variant can provide that the intermediate layer 1 of the core is possibly also formed by two or more layers of fibers superimposed on each other and whose thickness is such that the overall thickness remains within the limits foreseen and defined above for the overall thickness d1 of the said layer.

The fibers of said one or more layers of fibers can be made of thermoplastic materials that are chemically compatible with each other and/or also compatible with regards to their possible recycling.

The different layers that make up the intermediate layer of core 1 can present different types of agglomeration and/or possibly also intertwining of fibers and/or also provide different distributions of the orientation of the fibers according to the different spatial directions. For example, each layer of fibers can provide a predominant orientation direction of the fibers along which the majority of the fibers are oriented regardless of whether they are simply agglomerated as in a non-woven fabric or otherwise held together, for example in the form of weaving and/or in the form of fabric or mesh.

According to an embodiment, the fibers of the intermediate layer of the core, both in the single-layer variant and in the variant consisting of two or more superimposed layers of fibres, may have been subjected to a treatment which alternatively or in combination determines a compression of the fibres, i.e. a reduction of the thickness of the said layer(s) of fibers from an initial thickness to a final thickness which is between the said 1 and 3.8 mm and/or an adhesion of the said fibers to each other at the points of mutual contact. This can also apply to only one of the layers of fibers that form the intermediate layer of the core when this is made in the multilayer variant. In the single-layer variant the fibers can be made to adhere to each other at the contact points thanks to the said treatment for the entire thickness d1 of the fiber layer or only for part of the same or for areas of the same, in particular for a pre-established depth of the overall thickness d1 starting from the respective face of the intermediate layer of core 1 towards the center thereof.

The process to obtain this effect can consist of a transient heating of the fibers to a pre-established softening or at least superficial melting temperature of the fibers and an optional compression of the fiber layer(s) in the direction of its thickness. The temperature and duration depend on the type of thermoplastic material of the fibres.

The transient heating and optional compression are followed by a cooling phase.

The application step on one or two opposite faces of the intermediate core layer 1 of the coating layers 2 and 3 can be carried out either in a subsequent step or at the same time as the said heating and optional compression step in the direction of the thickness of the called core layer 1 fiber layers.

In particular, and advantageously, the materials of which these covering layers are made are chosen from thermoplastic materials that are chemically compatible with at least a fraction of the thermoplastic materials of the fibers of the intermediate layer of core 1.

The covering layers 2 and 3 are fixed to the intermediate core layer 1, preferably by means of a thermobonding process, whereby the thermal energy applied for said thermal bonding can also be such as to cause a transient heating effect of the fibers of the layer of core 1 and for the entire thickness of the core 1 layer and/or only for a part of it.

Thanks to the thermobonding process and the use of chemically compatible thermoplastic materials for the different layers it is possible to avoid the use of adhesive and/or compatibilizing material between the layers with advantages relating to cost, weight and the production process, also keeping taking into account the fact that adhesive materials often cause problems with contamination of production lines.

The intermediate core layer 1 can be provided with a weight per unit area of about 250 to about 500 g/m2.

An embodiment variant may provide an intermediate layer of core 1 consisting of a layer of expanded thermoplastic material. In this case generally the material of said core 1 is of the closed cell type, unlike the previous executive example in which the agglomerate of fibers constitutes a material of the open cell type.

Also in the case of this variant, the expanded thermoplastic material is preferably selected from thermoplastic materials chemically compatible with those of the covering layers 1 and 2.

The thickness d1 of the intermediate core layer in the form of expanded thermoplastic material also remains defined in this variant as a function of the thicknesses of the covering layers 2 and 3 and in such a way as to maintain the overall thickness in the thickness range from approximately 2 to approximately 4 mm.

Preferably the expanded thermoplastic material has a density of about 50 to about 200 Kg/m3.

Possible examples of expanded thermoplastic materials are for example EPP, i.e. expanded polypropylene or EPE, i.e. expanded polyethylene, or EPET, i.e. expanded polyester. However, these examples are not to be considered limiting or exhaustive as it is possible to envisage other types of expanded thermoplastic materials.

Even in the case of this executive variant which provides for the intermediate core layer 1 made of expanded thermoplastic material, the coupling of the two covering layers 2 and 3 preferably takes place using without using adhesives and in particular thermobonding techniques.

Similarly to the embodiment which provides for an intermediate layer of core 1 made up of thermoplastic fibres, it is possible to provide, as an executive variant, that the intermediate layer of core 1 is made up of two or more layers of expanded thermoplastic material coupled together and provided with thicknesses such that an identical overall thickness d1 of said layer 1 is maintained, defined according to the range of overall thicknesses of the slab or panel and the thicknesses d2 and d3 of the covering layers as indicated above.

Even the densities of the two or more layers of expanded material coupled together to form the intermediate layer of core 1 can be different for each of the said layers, but in any case such as to guarantee an overall average density within the density range indicated above, or from 50 to 200 Kg/m3.

The expanded thermoplastic material of the said two or more layers that form the intermediate core layer 1 can be identical for all the said layers, the said layers being differentiated from each other, for example, for the density and/or for the thickness and/or for the configuration of the cells such as, for example, open cells or closed cells or each of the said layers is made of a thermoplastic material or a mixture of different expanded thermoplastic materials. In this last case it is also further possible to combine the difference in the expanded thermoplastic materials of the said layers that constitute the intermediate core layer with differences relating, for example, to the density and/or thickness and/or configuration of the cells, such as for example open cells or closed cells.

The layers of expanded thermoplastic material according to the aforementioned variant can also be coupled together by thermobonding.

According to yet another possible variant, the intermediate layer of core 1 can be constituted by two or more layers superimposed and coupled with each other, one or more of said layers being constituted by agglomerates of fibers according to one or more alternative shapes envisaged for the first more variant described above and/or by one or more layers of expanded thermoplastic material according to one or more of the alternative shapes envisaged for the second variant described above.

Also in this case the thicknesses of the individual layers are defined in such a way that the overall thickness remains within the range of thicknesses defined as a function of the overall thickness range of the slab or panel indicated above and as a function of the thicknesses d2 and d3 of the covering layers 2 and 3.

Similarly, the weight per unit area of the intermediate core layer 1 must be established in such a way that the overall weight of the panel or plate remains in the range of 700 to 1000 g/m2 and/or the overall average density of the intermediate core layer 1 is included in the range from 50 to 200 Kg/m3.

As regards the covering layers 2 and 3, a first variant provides that these are made up of a single-layer film of thermoplastic material compatible with the thermoplastic materials of which the intermediate layer of core 1 is made or at least the interface layer of the intermediate layer of core 1 to which a covering layer 2 or 3 is coupled.

The single-layer thermoplastic film is preferably a continuous film obtained by extrusion and has a thickness of about 200 to about 400 microns.

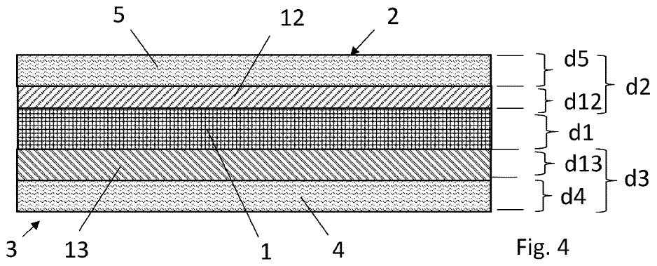

Also in relation to the coating layers 2 and 3, at least one of these can be made from a multilayer film as indicated in FIGS. 2, 3 and 4 which show different alternatives in which in FIG. 2 it is only the coating layer 3 that is made up of two layers superimposed and coupled together which are indicated with 13 and 4, in FIG. 3 only the covering layer 2 is made up of two layers superimposed and coupled which are indicated with 12 and 5 and in FIG. 4 both coating layers are made up of two layers superimposed and coupled which are indicated with 13 and 4 for the coating layer 3 and with 12 and 5 for the coating layer 2.

It is clear that although the examples show cladding layers made up of two layers of material coupled together, it is also possible to provide more than two layers for one of the cladding layers or for both cladding layers 2 and 3 being a number of layers that the said two covering layers 2 and 3 constitute identical for both layers and/or different for both layers.

The two layers that form the or more thermoplastic film of which a coating layer is made according to this variant can be made up of different thermoplastic materials and/or have different thicknesses and these differences can exist within the same multilayer film that forms one of the coating layers 2 and 3, said multilayer film being identical for each of the two coating layers or the layers of the multilayer film of each of the two coating layers comprising at least one identical layer in the two multilayer films of the said two coating layers at least one layer different between the two films that form the said two coating layers 2 and 3.

In relation to the differences in the thermoplastic material, it is preferable that a chemical compatibility of the said layers 4, 5, 12 and 13 is maintained with each other and with the intermediate layer of core 1.

In relation to the individual thicknesses indicated respectively with d4, d5, d12 and d13 in FIGS. 2 to 4, these can be chosen in such a way that the thickness of the multilayer film remains within the range of approximately 200 to approximately 500 microns.

At least one coating layer can have thicknesses smaller or greater than said range, this greater or lesser thickness relative to said range being compensated respectively with a corresponding the decrease and/or increase in the thickness of t other coating layer.

Furthermore, it is also possible to provide that the compensation of greater or lesser thicknesses of the covering layers with respect to the range from 200 to 400 microns occurs by modifying the thickness d1 of the intermediate core layer 1, and this however maintaining the overall thickness range of the plate or of the panel within the range from approximately 2 to approximately 4 mm.

In a possible embodiment at least one of the at least two layers of the multilayer film can be constituted by a layer of fibers of thermoplastic material which is coupled to at least one further layer in the form of a continuous film preferably by thermobonding.

The coupling can be carried out in such a way as to bring the film into a condition of viscosity such as to at least partially penetrate the layer of fibres, or to at least partially surround the said fibers by incorporating them into the film or wrapping them therein at least in part.

The multilayer film that forms at least one of the coating layers 2 and 3 can be made beforehand, for example by co-extrusion of the two or more layers, or the coupling by thermobonding can take place in a hot calendering process of the said at least two layers.

Alternatively, the layers that make up the slab or panel according to one or more of the variants and embodiments described above can be superimposed on each other and subsequently coupled together all together by means of a thermobonding process carried out according to any of the known variants of the said process.

### Example 1

The characteristics of the plate or panel according to the present invention were measured with reference to a sample of said plate which includes the following structure:

An intermediate core layer consisting of a non-woven fabric of PP-PET fibers and having an overall thickness of 2.mm

A cladding layer coupled to each of the two opposite faces of the core layer consisting of a PP thermoplastic material and having a thickness of 0.3 mm

The cladding layers were coupled to the intermediate core layer by thermobonding performed by compressing the layers together and simultaneously heating them at a temperature of 180° C. for a time of 40 s.

The overall thickness of the panel is 2.8 mm and the weight per unit area is 1000 g/m2.

The main characteristics of the panel are shown in table 1

The panel was found to be three-dimensionally formable. The panel surfaces were found to be workable for the application of three-dimensional surface structures using embossing or similar processes.

### Example 2

The characteristics of the plate or panel according to the present invention were measured with reference to a sample of said plate which includes the following structure:

An intermediate core layer consisting of a non-woven fabric of PP-PET fibers and having an overall thickness of 2, mm

A covering layer coupled to each of the two opposite faces of the core layer consisting of a PP thermoplastic material and having a thickness of 0.3 mm in turn combined with a PP and glass fiber fabric with a thickness of 0.25 mm

The cladding layers were coupled to the intermediate core layer by thermobonding performed by compressing the layers together and simultaneously heating them at a temperature of 180° C. for a time of 40 s.

The overall thickness of the panel is 2.6 mm and the weight per unit area is 1500 g/m2.

The main characteristics of the panel are shown in table 1

The panel was found to be three-dimensionally formable.

The panel was found to be coupled to aesthetic finishes through thermobonding treatment without the use of glues or adhesives.

TABLE 1

| | | | State | State | State | | |
|---|---|---|---|---|---|---|---|
| | | | of | of | of | | |
| | | | the | the | the | Example | Example |
| | Technique | UM | art 1 | art 2 | art 3 | 1 | 2 |
| Basis | | g/m2 | 2260 | 2770 | 2100 | 1000 | 1500 |
| weight | | | | | | | |
| Thickness | | Mm | 2.0 | 2.5 | 2.3 | 2.8 | 2.6 |
| Flexural | ISO | MPa | 20 | 35 | 27 | 6.1 | 12.3 |
| Resistance | 178 | | | | | | |
| Bending | ISO | MPa | 1600 | 2600 | 1800 | 250 | 510 |
| module | 178 | | | | | | |
| Flexural | | N · | 12800 | 40000 | 21000 | 5500 | 9000 |
| inertia | | mm | | | | | |
| Cantilever | | | | | | | |
| Bending | | | | | | | |
| (10′ 23° C., | | | | | | | |
| 350 mm) | | | | | | | |
| | | mm | 34 | 25 | 30 | 12 | 0 |
| Impact | ISO | | | | | | |
| resistance | 179 | | | | | | |
| at 23° C. | met · 2 | | | | | | |
| | KJ/m2 | 4 | 4.2 | 6.0 | No | No | |
| | | | | | break | break | |

The invention claimed is:

1. A multilayer plate or panel, comprising:
at least three layers superimposed and coupled to each other, which comprise:
an intermediate core layer having a skin layer coupled to each of opposing faces of the intermediate core layer,
wherein said skin layers comprise a thermoplastic material and are thermally bonded and/or fixed to a respective face of said intermediate core layer,
wherein the intermediate core layer is made from a thermoplastic material and is provided as an agglomerate of at least partly thermoplastic fibers and/or of an expanded thermoplastic material,
wherein said agglomerate is obtained by compression and simultaneous heating from a pre-established initial thickness to a final thickness of about 1 mm to about 3.8 mm having an average density of from 50 to 300 Kg/m³ and a weight per unit of surface from 250 to 500 g/m².

2. The multilayer plate or panel according to claim 1, wherein said skin layers comprise a continuous extruded film of said thermoplastic material.

3. The multilayer plate or panel according to claim 1, said skin layers are made from thermoplastic fibers mixed or intertwined with other synthetic or natural fibers and thermally pressed.

4. The multilayer plate or panel according to claim 1, wherein said agglomerate comprises at least one layer of a non-woven fabric of thermoplastic fibers and is open-celled.

5. The multilayer plate or panel according to claim 1,
wherein said agglomerate comprises at least one layer of a non-woven fabric of thermoplastic fibers mixed and intertwined with other fibers, synthetic or natural, and compacted under heating,
wherein said agglomerate comprises thermoplastic fibers which adhere to each other through chemical/physical coupling at points of contact of said thermoplastic fibers to each other, forming a network of fibers connected to each other which delimit hollow areas following said heating.

6. The multilayer plate or panel according to claim 1, wherein said agglomerate comprises a layer of non-woven fabric of thermoplastic fibers mixed and intertwined with other synthetic or natural fibers and further bound and pressed with an acrylic or vinyl based binder resin or Styrene-Butadiene Rubber (SBR).

7. The multilayer plate or panel according to claim 1, wherein the skin layers each have a thickness of about 200 to about 400 microns.

8. A multilayer plate or panel plate or panel, comprising:
at least three layers superimposed on each other and coupled to each other which comprise:
an intermediate core layer having a skin layer coupled to each of opposing faces of the intermediate core layer,
wherein said skin layers comprise a thermoplastic material and are bonded and/or thermally fixed to a respective face of said intermediate core layer, and
wherein the intermediate core layer is made from a thermoplastic material and comprises one or more layers of expanded thermoplastic material, said intermediate core layer having a density from about 50 to about 200 Kg/m³ and/or a thickness from about 2 to about 3 mm.

9. The multilayer plate or panel according to claim 8, wherein said expanded thermoplastic material comprises expanded polypropylene (EPP), expanded polyethylene (EPE), or expanded polyester (EPET).

10. The multilayer plate or panel according to claim 8, wherein an overall thickness of said one or more layers of expanded thermoplastic material is about 2 to 3 mm, and/or a weight per unit of surface area is between about 250 and about 500 g/m², and/or an average density of said intermediate core layer (1) is between about 50 and about 200 Kg/m³.

11. The multilayer plate or panel according to claim 8,
wherein at least one of said two skin layers is multilayer and has at least one layer comprising an extruded thermoplastic film superimposed and coupled to at least one additional layer disposed on an opposite face of said extruded thermoplastic film to the face adhering against the intermediate core layer, or between said extruded thermoplastic film and said intermediate core layer, and
wherein said at least one additional layer which forms one of two coating layers comprising an additional continuous film and/or a layer of thermoplastic fibers configured as an agglomeration of fibers, scattered fibers, and/or fiber mats.

12. The multilayer plate or panel according to claim 8, wherein the intermediate core layer is multilayer and comprises a plurality of layers, of which at least one is configured as a non-woven fabric of fibers with a mixture containing thermoplastic fibers, or a layer of expanded thermoplastic material, remaining layer or layers comprising thermoplastic fibers and/or an expanded thermoplastic material, the remaining layer or layers being configured as a non-woven fabric or fibers intertwined or interwoven with a prevailing fiber orientation identical or different from layer to layer.

13. The multilayer plate or panel according to claim 8, wherein an overall weight of the multilayer plate or panel per surface unit is from about 800 to about 1000 g/m² and/or an overall thickness of the multilayer plate or panel is from 2 to 4 mm.

14. The multilayer plate or panel according to claim 8, wherein said skin layers and the intermediate core layer are coupled together by thermobonding and without adhesives between said skin layers and the intermediate core layer.

15. The multilayer plate or panel according to claim 13, wherein layers forming the skin layers having a multilayer structure and/or layers of said intermediate core layer having a multilayer structure are coupled together by thermobonding and without adhesives between individual layers.
